(19) United States
(12) Patent Application Publication
(10) Pub. No.: US 2010/0319113 A1
(43) Pub. Date: Dec. 23, 2010

(54) Chemical Protective Fabric

(75) Inventors: Moshe Rock, Brookline, MA (US); David Costello, Marblehead, MA (US); Jane Hunter, Manassas, VA (US)

Correspondence Address: FISH & RICHARDSON P.C. (BO), P.O. BOX 1022, MINNEAPOLIS, MN, 55440-1022, US

(73) Assignee: MMI-IPCO, LLC

(21) Appl. No.: 12/276,640

(22) Filed: Nov. 24, 2008

(51) Int. Cl. A62B 17/00

(52) U.S. Cl. 2/457; 2/458

(57) ABSTRACT

A chemical protective fabric garment includes a first fabric layer, and a barrier layer bonded to the first fabric layer. The barrier layer includes a nonwoven membrane that is formed of fibers with embedded particles having one or more detoxifying properties, such as being absorptive of hazardous gases and/or being catalytically destructive of hazardous gases.

### TECHNICAL FIELD

This disclosure relates to protective fabrics, and to protective garments incorporating such fabrics, and, more particularly, to chemical protective fabrics, chemical protective fabric garments and chemically protective garment systems.

### BACKGROUND

Currently, many military, homeland security, and first responder personnel are equipped with chemical protective cloth garments provided under the SARATOGA® brand, owned by Blucher GmbH, of Dusseldorf, Germany. In one implementation, the SARATOGA chemical protective clothing system consists of a heavy, woven outer shell, formed of cotton or a cotton/nylon mix that is liquid repellent, worn over an intermediate liner consisting of a filter material formed of a breathable membrane, e.g. a nonwoven cloth, disposed atop an inner textile carrier containing activated carbon absorber. The breathable membrane, which has selective impermeability to chemical agents in a form of vapor and/or liquid, is constructed to permit limited moisture vapor transmission, but it also generates high levels of heat stress during periods of high activity by the wearer. The activated carbon absorbers used in the SARATOGA system are incorporated into fibers of the textile carrier, or, in other implementations, spherical activated carbon absorbers are adhered to the textile carrier with an adhesive binder or resin.

### SUMMARY

According to the disclosure, a chemical protective fabric garment includes a first fabric layer, and a barrier layer bonded to the first fabric layer. The barrier layer includes a nonwoven membrane that is formed of fibers with embedded particles that have one or more detoxifying properties, such as being absorptive of hazardous gases and/or being catalytically destructive of hazardous gases.

Preferred implementations may include one or more of the following additional features. The particles include magnetite nanoparticles. The nanoparticles have an average particle size of about 1 nm to about 100 nm. The magnetite nanoparticles include oxime-modified magnetite particles, which are catalytically destructive of hazardous gases. The particles are modified with an antidote selected from 2-pralidoxime and poly(4-vinylpyridine-N-phenacyloxime-co-acrylic acid). The particles are configured to catalyze hydrolysis of an organophosphate compound, at neutral pH. The particles are configured to catalyze the hydrolysis of an organophosphate compound in a temperature range of about 50° F. to about 120° F. (e.g., about 69° F. to about 73° F.). The organophosphate compound includes organophosphate ester. The organophosphate compound is an organophosphorus pesticide or a chemical warfare agent. The particles have catalytic destructive properties, for catalytic destruction of absorbed hazardous gases. The barrier layer has an air permeability of about 0 ft³/ft²/min to about 20 ft³/ft²/min, tested according to ASTM D-737, under a pressure difference of ½ inch of water across the barrier layer. The barrier layer has a water resistance of about 500 mm of water to about 15,000 mm of water, tested according to AATCC 127-2003, option 2. The barrier layer has a moisture vapor transmission rate of about 2,000 g/m²/24 hrs to about 12,000 g/m²/24 hrs, tested according to ASTM E96 inverted cup. The barrier layer has a weight of about 2 grams per square meter to about 20 grams per square meter. The barrier layer has a thickness of about 1 micrometer to about 50 micrometers. The nonwoven membrane is a nanofiber membrane. The nonwoven membrane is an electrospun nanofiber membrane. The electrospun nanofiber membrane is formed of fibers having fiber diameters in the range of about 50 nanometers to about 1,500 nanometers. The particles have an average particle size of about 1 nm to about 100 nm. The nonwoven membrane is a melt blown membrane. The melt blown membrane is formed of fibers having fiber diameters in the range of about 300 nanometers to about 2,000 nanometers. The nonwoven membrane includes multiple nonwoven membrane layers. At least one of the nonwoven membrane layers is a melt blown membrane. At least one of the nonwoven membrane layers is an electrospun membrane. The nonwoven membrane layers include one or more melt blown membrane layers and one or more electrospun membrane layers. The first fabric layer is formed of yarns or fibers with embedded particles of activated carbon. The first fabric layer is formed of yarns or fibers with embedded particles that are absorptive of hazardous gases and/or are catalytically destructive of hazardous gases. The chemical protective fabric garment may also include a second fabric layer. The barrier layer is disposed between the first and second fabric layers. The first fabric layer and/or the second fabric layer are formed of yarns or fibers with embedded particles of activated carbon. The first fabric layer and/or the second fabric layer are formed of yarns or fibers with embedded particles that are absorptive of hazardous gases and/or are catalytically destructive of hazardous gases.

In another aspect, a method of forming a chemical protective fabric includes bonding a barrier layer including a nonwoven membrane formed of fibers with embedded particles to a first fabric layer. The embedded particles have one or more detoxifying properties, such as being absorptive of hazardous gases and/or being catalytically destructive of hazardous gases.

Implementations may include one or more of the following additional features. The method includes forming the barrier layer. Forming the barrier layer includes forming nanofibers with the particles embedded therein. Forming the barrier layer includes stacking multiple membrane layers on top of each other, and mechanically processing the stack of membrane layers. Mechanically processing the stack of membrane layers includes applying pressure to the stack of membrane layers. Heat and pressure is applied by passing the stack of membrane layers through a plurality of rollers (e.g., heated rollers). Stacking the multiple membrane layers includes electrospinning a nonwoven membrane layer onto a carrier membrane layer. The method also includes forming the carrier membrane out of a melt-blown non-woven membrane. The carrier membrane may be formed using a melt blowing operation. The particles include magnetite particles. The particles include oxime-modified magnetite particles. The method includes bonding the barrier layer to a second fabric layer.

According to another aspect, a chemical protective fabric garment system includes an inner layer garment, a thermal fabric garment configured to be worn over the inner layer garment, and an outer shell garment configured to be worn over the thermal fabric garment. The inner layer garment has an inner surface, towards a wearer's skin, brushed for increased surface area to provide enhanced absorption (e.g., of liquid sweat) and reduced touching points upon the skin. The thermal fabric garment has at least one raised surface. The outer shell garment includes a first fabric layer, and a barrier layer bonded to the first fabric layer. The barrier layer includes a nonwoven membrane that is formed of fibers with embedded particles having one or more detoxifying properties, such as being absorptive of hazardous gases and/or being catalytically destructive of hazardous gases.

Preferred implementations may include one or more of the following additional features. The particles include magnetite particles. The magnetite particles include magnetite nanoparticles. The magnetite nanoparticles have an average particle size of about 1 nm to about 100 nm. The magnetite particles include oxime-modified magnetite particles. The particles are modified with an antidote selected from 2-pralidoxime and poly(4-vinylpyridine-N-phenacyloxime-co-acrylic acid). The particles are configured to catalyze hydrolysis of an organophosphate compound, at neutral pH. The particles are configured to catalyze the hydrolysis of an organophosphate compound in a temperature range of about 50° F. to about 120° F. (e.g., about 69° F. to about 73° F.). The organophosphate compound includes organophosphate ester. The organophosphate compound is an organophosphorus pesticide or a chemical warfare agent. The particles have catalytic destructive properties, for catalytic destruction of absorbed hazardous gases. The barrier layer has an air permeability of about 0 ft³/ft²/min to about 20 ft³/ft²/min, tested according to ASTM D-737, under a pressure difference of ½ A inch of water across the barrier layer. The barrier layer has a water resistance of about 500 mm of water to about 15,000 mm of water, tested according to AATCC 127-2003, option 2. The barrier layer has a moisture vapor transmission rate of about 2,000 g/m²/24 hrs to about 12,000 g/m²/24 hrs, tested according to ASTM E96 inverted cup. The barrier layer has a weight of about 2 grams per square meter to about 20 grams per square meter. The barrier layer has a thickness of about 1 micrometer to about 50 micrometers. The nonwoven membrane includes an electrospun nanofiber membrane. The nonwoven membrane includes a melt blown membrane. The melt blown membrane is formed of fibers having fiber diameters in the range of about 300 nanometers to about 2,000 nanometers. The nonwoven membrane includes multiple membrane layers. At least one of the membrane layers is a melt blown membrane. At least one of the membrane layers is an electrospun membrane. The membrane layers include one or more melt blown membrane layers and one or more electrospun membrane layers. The first fabric layer is formed of yarns or fibers with embedded particles of activated carbon. The first fabric layer is formed of yarns or fibers with embedded particles of activated carbon. The first fabric layer is formed of yarns or fibers with embedded particles that are absorptive of hazardous gases and/or are catalytically destructive of hazardous gases. The outer shell garment may also include a second fabric layer. The barrier layer is disposed between the first and second fabric layers. The first fabric layer and/or the second fabric layer are formed of yarns or fibers with embedded particles of activated carbon. The first fabric layer and/or the second fabric layer are formed of yarns or fibers with embedded particles that are absorptive of hazardous gases and/or are catalytically destructive of hazardous gases. The thermal fabric garment is formed of one or more yarns made of fibers carrying activated carbon particles. The thermal fabric garment is formed of one or more yarns made of fibers with embedded particles that are absorptive of hazardous gases and/or are catalytically destructive of hazardous gases. The thermal fabric garment is formed of synthetic yarns or fibers with embedded particles of activated carbon or active carbon fiber. The thermal fabric garment is formed of synthetic yarns or fibers with embedded particles that are absorptive of hazardous gases and/or are catalytically destructive of hazardous gases. The inner layer garment has a knitting construction selected from single jersey, plaited jersey, double knit, rib terry, terry loop and triple plaited terry. The inner layer garment has one or more properties selected from good water management, good stretch recovery, and kindness to a wearer's skin. The inner layer garment is formed of materials with flame retarding properties and/or no melt-no drip properties upon exposure to fire. The inner layer garment has enhanced flame retarding properties provided, at least in part, by active carbon fibers or activated carbon particles embedded in fibers of the inner layer garment. The inner layer garment has high absorption performance for hazardous chemicals including in the form of gas, vapor, mist, aerosol or liquid. The thermal fabric garment includes fibers including synthetic material selected from acrylic, acrylonitrile, nylon, and polyester. The thermal fabric garment includes fibers including natural fibers selected from cotton and wool. The thermal fabric garment is formed by a knitting process selected from circular knit and warp knit. The thermal fabric garment is formed by the process of circular knitting and has a knitting construction selected from terry, terry loop knit in regular plaiting, terry loop knit in reverse plaiting, and sliver knit. The thermal fabric garment has a knitting construction selected from regular plaiting and reverse plaiting, and one or both surfaces are physically brushed or raised by napping, brushing or sanding. The thermal fabric garment has one or both surfaces finished to form fleece, velour, shearling or pile. The thermal fabric garment is in stand-alone or laminated form. The thermal fabric garment has a large surface area and high three-dimensional bulk. The thermal fabric garment is single face or double face. The thermal fabric garment defines air flow paths of high tortuosity, which, combined with Brownian movement of hazardous chemical molecules, ensures suitably high probability of contact by hazardous chemical molecules with activated carbon particles embedded in and upon fibers. Activated carbon particles or active carbon fibers are embedded in and upon one or more of: stitch yarn, terry yarn and loop yarn. The thermal fabric garment includes elastomeric fibers in stitch yarn of regular plait and reverse plait constructions. The thermal fabric garment is formed by warp knit, with single face or double face knit or double needle bar construction.

In another aspect, a chemical protective fabric garment includes a first fabric layer, a second fabric layer, and a barrier layer disposed between the first and second fabric layers. The barrier layer includes a nonwoven membrane that is formed of fibers with embedded particles that have one or more detoxifying properties, such as being absorptive of hazardous gases and/or being catalytically destructive of hazardous gases.

Preferred implementations may include one or more of the following additional features. The particles include magnetite nanoparticles. The nanoparticles have an average particle size of about 1 nm to about 100 nm. The magnetite nanoparticles include oxime-modified magnetite particles, which are catalytically destructive of hazardous gases. The particles are modified with an antidote selected from 2-pralidoxime and poly(4-vinylpyridine-N-phenacyloxime-co-acrylic acid). The particles are configured to catalyze hydrolysis of an organophosphate compound, at neutral pH. The particles are configured to catalyze the hydrolysis of an organophosphate compound in a temperature range of about 50° F. to about 120° F. (e.g., about 69° F. to about 73° F.). The organophosphate compound includes organophosphate ester. The organophosphate compound is an organophosphorus pesticide or a chemical warfare agent. The particles have catalytic destructive properties, for catalytic destruction of absorbed hazardous gases. The barrier layer has an air permeability of about 0 ft³/ft²/min to about 20 ft³/ft²/min, tested according to ASTM D-737, under a pressure difference of ½ inch of water across the barrier layer. The barrier layer has a water resistance of about 500 mm of water to about 15,000 mm of water, tested according to AATCC 127-2003, option 2. The barrier layer has a moisture vapor transmission rate of about 2,000 g/m²/24 hrs to about 12,000 g/m²/24 hrs, tested according to ASTM E96 inverted cup. The barrier layer has a weight of about 2 grams per square meter to about 20 grams per square meter. The barrier layer has a thickness of about 1 micrometer to about 50 micrometers. The nonwoven membrane is a nanofiber membrane. The nonwoven membrane is an electrospun nanofiber membrane. The electrospun nanofiber membrane is formed of fibers having fiber diameters in the range of about 50 nanometers to about 1,500 nanometers. The particles have an average particle size of about 1 nm to about 100 nm. The nonwoven membrane is a melt blown membrane. The melt blown membrane is formed of fibers having fiber diameters in the range of about 300 nanometers to about 2,000 nanometers. The nonwoven membrane includes multiple nonwoven membrane layers. At least one of the nonwoven membrane layers is a melt blown membrane. At least one of the nonwoven membrane layers is an electrospun membrane. The nonwoven membrane layers include one or more melt blown membrane layers and one or more electrospun membrane layers. The first fabric layer is formed of yarns or fibers with embedded particles of activated carbon. The barrier layer is bonded to at least one of the first and second fabric layers (e.g., with an adhesive). The first fabric layer and the second fabric layer are formed of yarns or fibers with embedded particles of activated carbon.

In yet another aspect, a chemical protective fabric garment system includes a knit thermal fabric layer formed of synthetic yarns or fibers with embedded particles of activated carbon, the first knit thermal fabric layer having at least one raised surface with a large surface area and enhanced three-dimensional bulk; and an inner knit layer formed of one or more yarns made of fibers carrying activated carbon particles, or active carbon fibers, and having an inner surface, towards a wearer's skin, brushed for increased surface area to provide enhanced absorption (e.g., of liquid sweat) and reduced touching points upon the skin.

Preferred implementations may include one or more of the following additional features. The inner knit layer has a knitting construction selected from the group consisting of single jersey, plaited jersey, double knit, rib terry, terry loop and triple plaited terry. The inner knit layer also has an outer surface brushed for increased surface area and for increased tortuosity of the inner knit layer. The inner fabric layer has one or more properties selected from the group consisting of good water management, good stretch recovery, and kindness to a wearer's skin. The inner fabric layer is formed of materials with flame retarding properties and/or no melt-no drip properties upon exposure to fire. Preferably, the inner fabric layer has enhanced flame retarding properties provided, at least in part, by active carbon fibers or activated carbon particles embedded in fibers of the inner fabric layer. The inner fabric layer has high absorption performance for hazardous chemicals including in the form of gas, vapor, mist, aerosol or liquid. The knit thermal fabric layer includes fibers including synthetic material selected from the group consisting of acrylic, acrylonitrile, nylon, and polyester. The knit thermal fabric layer includes fibers including natural fibers selected from the group consisting of cotton and wool. The knit thermal fabric layer is formed by a knitting process selected from the group consisting of circular knit and warp knit. The knit thermal fabric layer is formed by the process of circular knitting and has a knitting construction selected from the group consisting of terry, terry loop knit in regular plaiting, terry loop knit in reverse plaiting, and sliver knit. The knit thermal fabric layer has a knitting construction selected from the group consisting of regular plaiting and reverse plaiting, and one or both surfaces are physically brushed or raised by napping, brushing or sanding. The knit thermal fabric layer has one or both surfaces finished with fleece, velour, shearling or pile. The knit thermal fabric layer is in stand-alone or laminated form. The knit thermal fabric layer has a large surface area and high three-dimensional bulk. The knit thermal fabric layer is single face or double face. The knit thermal fabric layer defines air flow paths of high tortuosity, which, combined with Brownian movement of hazardous chemical molecules, ensures suitably high probability of contact by hazardous chemical molecules with activated carbon particles embedded in and upon fibers. Activated carbon particles or active carbon fibers are embedded in and upon one or more of stitch yarn, terry yarn and loop yarn. The knit thermal fabric layer also includes elastomeric fibers in stitch yarn of regular plait and reverse plait constructions. The knit thermal fabric layer is formed by warp knit, with single face or double face knit or double needle bar construction. The chemical protective fabric garment system also includes an outer protective fabric shell. The outer protective shell may include yarns and/or fibers containing particles absorptive of hazardous gases, for example, oxime-modified magnetite particles, such as those described in “Nerve Agent Destruction by Recyclable Catalytic Magnetic Nanoparticles,” by Lev Bromberg and T. Alan Hatton, Ind. Eng. Chem. Res., 44 (21), 7991-7998, (2005), the entire disclosure of which is incorporated herein by reference. In some cases, the magnetite nanoparticles are modified with an antidote selected from 2-pralidoxime and poly(4-vinylpyridine-N-phenacyloxime-co-acrylic acid). The magnetite particles may be embedded in the yarn and/or fibers of the outer protective shell. The particles may also be embedded in a binder (e.g., a chemical binder, latex, or resin) applied to the outer protective shell. The binder is may be a chemical binder, latex, or resin.

According to another aspect, a multilayer chemical protective fabric garment includes a first inner fabric layer, a first outer fabric layer and a first intermediate layer disposed between the first inner fabric layer and the first outer fabric layer. The first intermediate layer includes a continuous web of active carbon fibers.

Implementations may include one or more of the following additional features. The continuous web of active carbon fibers is bonded to at least one of the first inner fabric layer and the first outer fabric layer. The continuous web of active carbon fibers includes electro spun fibers of active carbon, such as those developed by eSpin Technologies, Inc., of Chattanooga, Tenn. The continuous web of active carbon fibers includes direct spun fibers of carbon.

In yet another aspect, a chemical protective fabric garment includes a continuous web of yarns and/or fibers containing particles that absorb hazardous gases.

Preferred implementations may include one more of the following additional features. The particles have catalytic destructive properties for catalytic destruction of absorbed hazardous gases. The particles include magnetite nanoparticles, e.g., oxime-modified magnetite particles. The magnetite nanoparticles are modified with an antidote such as 2-pralidoxime (PAM) or poly(4-vinylpyridine-N-phenacyloxime-co-acrylic acid). The magnetite nanoparticles are configured to catalyze hydrolysis of an organophosphate (OP) compound, at neutral pH, and, preferably, within a temperature range of between about 50° F. to about 120° F. (e.g., about 69° F. to about 73° F. (i.e., room temperature)). The organophosphate compound may include organophosphate ester. The organophosphate compound is an organophosphorus pesticide or a chemical warfare agent, e.g., Sarin or Soman. The particles (i.e., the particles having) catalytic destructive properties are embedded in the yarn and/or fibers, e.g., during extrusion of the filament yarn. In some cases, the particles are embedded in a binder, e.g., a chemical binder, latex, or resin, applied to the fabric garment. The continuous web of yarns and/or fibers has a knit construction. More specifically, the continuous web of yarns and/or fibers has a knitted construction selected from single jersey, single jersey plaited, double knit, terry, and terry loop.

In another aspect, a method of forming a chemical protective fabric includes combining yarns and/or fibers in a continuous web, and applying a binder including particles absorptive of hazardous gases to the fabric garment.

Implementations may include one or more of the following additional features. The step of combining yarn and/or fibers in a continuous web includes combining yarn and/or fibers to form a single jersey, single jersey plaited, double knit, terry or terry loop construction. The step of applying the binder includes applying the binder by padding or a face application, e.g., foam application, spray application, coating and/or printing. The binder is latex, resin, or a chemical binder. The particles may include oxime-modified magnetite nanoparticles.

The details of one or more implementations are set forth in the accompanying drawings and the description below. Other features, objects, and advantages will be apparent from the description and drawings, and from the claims.

### DESCRIPTION OF DRAWINGS

FIG. 1. is a somewhat diagrammatic view of a first responder garbed in a chemical protective fabric garment system.

FIG. 2 is an exploded side section view of a chemical protective fabric.

FIG. 3 is a cross-sectional view of an example of a fabric laminate for use in an outer fabric shell of the protective fabric garment system of FIG. 1.

FIG. 4 is a magnified plan view of a nonwoven nanofiber membrane.

FIG. 5 is a schematic view of an electrospinning process for fabricating a nonwoven nanofiber membrane.

FIG. 6 is schematic view of a melt blowing process for fabricating a nonwoven membrane.

FIGS. 7-9 are schematic representations of systems for processing nonwoven membranes for use in chemical protective fabric laminates.

FIG. 10 is a cross-sectional view of an example of a chemically protective fabric for use in an outer fabric shell of the protective fabric garment system of FIG. 1.

### DETAILED DESCRIPTION

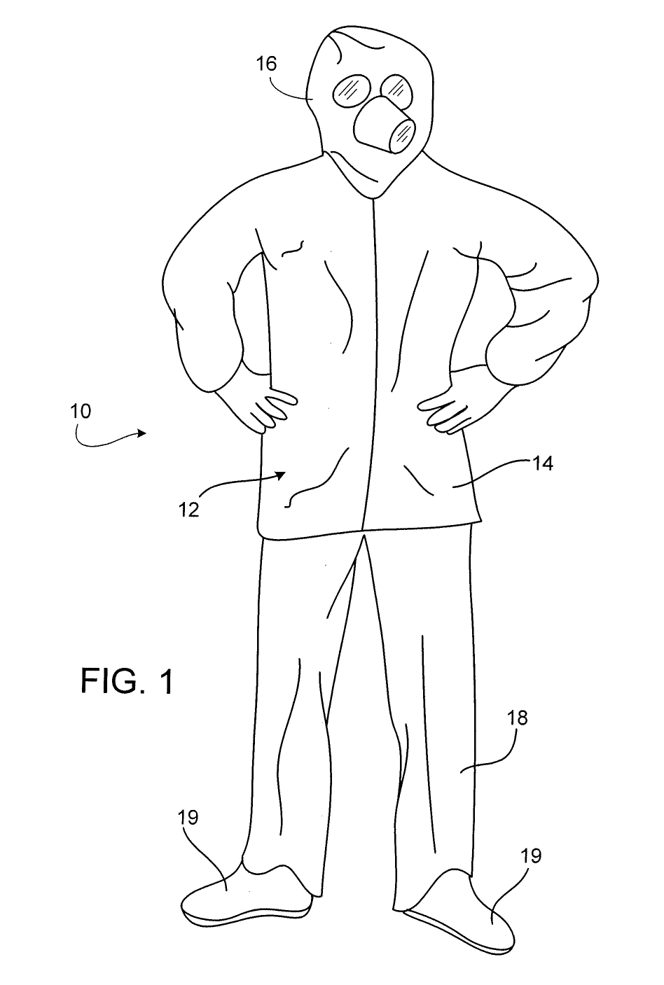

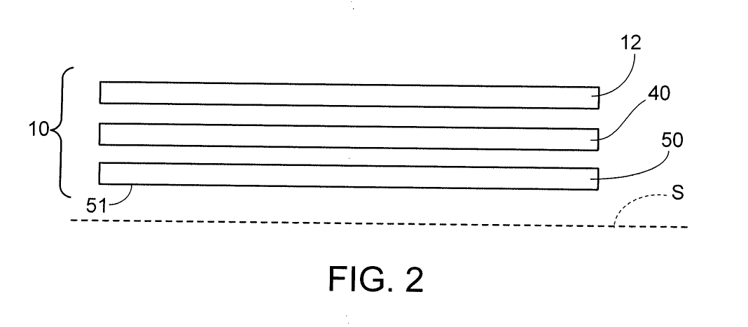

Referring to FIGS. 1 and 2, a chemical protective fabric garment system 10 consists of an outer fabric shell 12, typically including a zippered, upper garment portion 14 (with an integral hood 16) and a lower garment portion 18 (extending over the uppers of the wearer's boots 19); an intermediate thermal fabric layer (thermal fabric garment) 40; and a first, inner layer garment 50, all now to be described in more detail.

### Outer Fabric Shell (12)

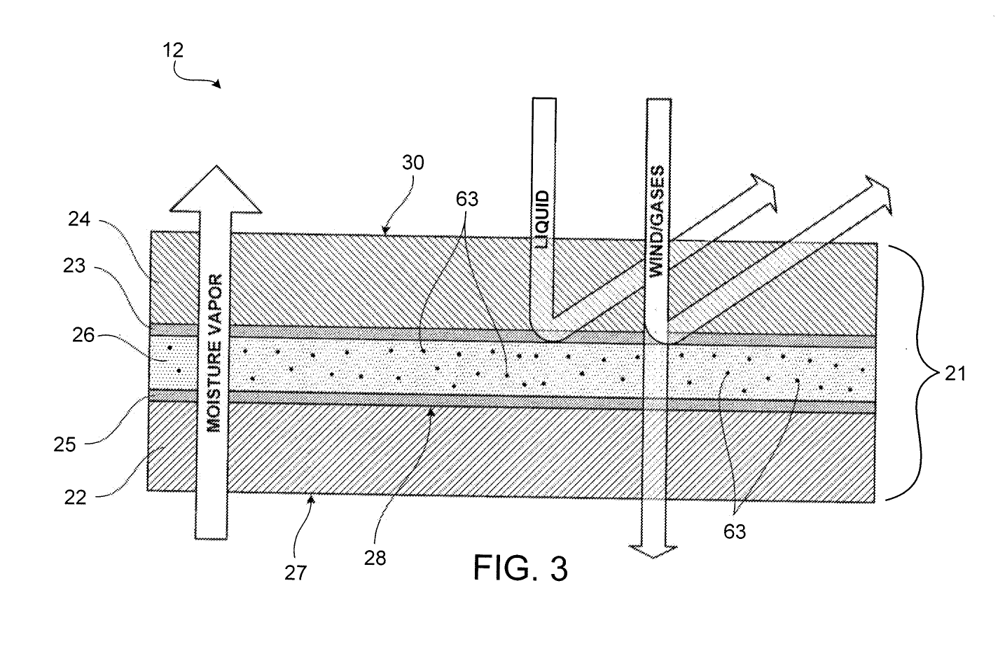

Referring to FIG. 3, the outer shell 12 is formed of a fabric laminate 21 including an inner fabric layer 22, an outer fabric layer 24, and a barrier layer 26 containing particles 63 that have one or more detoxifying properties, such as being absorptive of hazardous gases and/or being catalytically destructive of hazardous gases. For example, suitable particles include particles that are absorptive of hazardous gases such as magnetite particles, e.g., magnetite nanoparticles, e.g., oxime-modified magnetite nanoparticles and particles that have catalytic destructive properties, for catalytic destruction of hazardous gases, such as oxime-modified magnetite particles, e.g., oxime-modified magnetite nanoparticles. The barrier layer 26 is positioned between and bonded to the inner and outer fabric layers. Due to the construction of the fabric laminate 21, the outer shell 12 is provided with predetermined air permeability, resistance to penetration by liquid, and/or moisture vapor transmission. For example, the barrier layer 26 may be constructed to have an air permeability of about 0 ft³/ft²/min to about 20 ft³/ft²/min (tested according to ASTM D-737, under a pressure difference of ½ inch of water across the barrier layer 26), a water resistance of about 500 mm of water to about 15,000 mm of water (tested according to AATCC 127-2003, option 2), and a moisture vapor transmission rate of about 2,000 g/m²/24 hrs to about 12,000 g/m²/24 hrs (tested according to ASTM E96 inverted cup).

The inner fabric layer 22 has a woven, non-woven or knit construction (e.g., warp knit, single jersey knit, plated single jersey knit, double knit, tricot knit, and/or terry sinker loop knit). The inner fabric layer 22 includes a first surface 27, which faces inward, towards a wearer's body (e.g., towards the intermediate thermal fabric layer 40) during use, and second surface 28, which is bonded to the barrier layer 26. The first surface 27 can be raised and/or brushed. The inner fabric layer 22 may be constructed from fibers containing activated carbon particles for added protection against hazardous chemicals.

Alternatively or additionally, the inner fabric layer 22 may be constructed from fibers with embedded particles that have one or more detoxifying properties, such as being absorptive of hazardous gases and/or being catalytically destructive of hazardous gases. Suitable particles include particles that are absorptive of hazardous gases such as magnetite particles, e.g., magnetite nanoparticles, e.g., oxime-modified magnetite nanoparticles and particles that have catalytic destructive properties, for catalytic destruction of hazardous gases, such as oxime-modified magnetite particles, e.g., oxime-modified magnetite nanoparticles.

Referring still to FIG. 3, the outer fabric layer 24 may be a woven material. In some cases, the outer fabric layer 24 may have stretch in at least one direction, e.g., one-way or two-way stretch. In some examples, the outer fabric layer 24 may be formed from a low stretch or no stretch fabric. In some cases, the outer fabric layer 24 is treated with a durable water repellent, thereby inhibiting the transport of liquid water from the outer surface 30 toward an inner surface 27 of the garment 10. The outer fabric layer 24 may also be constructed from fibers containing activated carbon particles for added protection against hazardous chemicals.

Alternatively or additionally, the outer fabric layer 24 may be constructed from fibers with embedded particles that have one or more detoxifying properties, such as being absorptive of hazardous gases and/or being catalytically destructive of hazardous gases. Suitable particles include particles that are absorptive of hazardous gases such as magnetite particles, e.g., magnetite nanoparticles, e.g., oxime-modified magnetite nanoparticles and particles that have catalytic destructive properties, for catalytic destruction of hazardous gases, such as oxime-modified magnetite particles, e.g., oxime-modified magnetite nanoparticles.

The barrier layer 26 is positioned between the inner and outer fabric layers 22, 24. As mentioned above, the barrier layer 26 contains particles having one or more detoxifying properties. The barrier layer 26 allows water vapor, e.g., a wearer's body humidity, to pass through, but at the same time serves as a gas and liquid barrier that blocks gases and liquids from passing inwardly through the barrier layer 26 toward the wearer's body and has a high absorption affinity for hazardous chemicals, e.g., in gaseous, vaporous or mist, or liquid state.

The barrier layer 26 can provide added protection against hazardous chemicals without substantial effect on the weight or overall bulk of the outer shell 12. The barrier layer 26 has a weight of about 2 grams per square meter to about 20 grams per square meter, and a thickness of about 1 micrometer to about 50 micrometers. This allows the barrier layer 26 to provide an additional layer of protection without sacrificing comfort.

Referring again to FIG. 3, first and second adhesive layers 23, 25 secure the first barrier layer 26 to opposed sides of the inner fabric layer 22 and the outer fabric layer 24. The first and second adhesive layers 23, 25 can be applied to the opposed surfaces of the inner and outer fabric layers 22, 24 and/or to the barrier layer 26 before joining the layers together. The first adhesive layer 23 is positioned between the barrier layer 26 and the outer fabric layer 24 for adhering the barrier layer 26 to the outer fabric layer 24. Similarly, the second adhesive layer 25 is positioned between the barrier layer 26 and the inner fabric layer 22 for adhering the barrier layer 26 to the inner fabric layer 22. The first and second adhesive layers 23, 25 are applied is such a manner as to avoid restriction of the moisture vapor transmission and/or air permeability of the barrier layer 26. For example, the first and second adhesive layers 23, 25 can be applied in a dot coating pattern. The first and second adhesive layers 23, 25 can be applied, e.g., with rotary printing and/or gravure rolling.

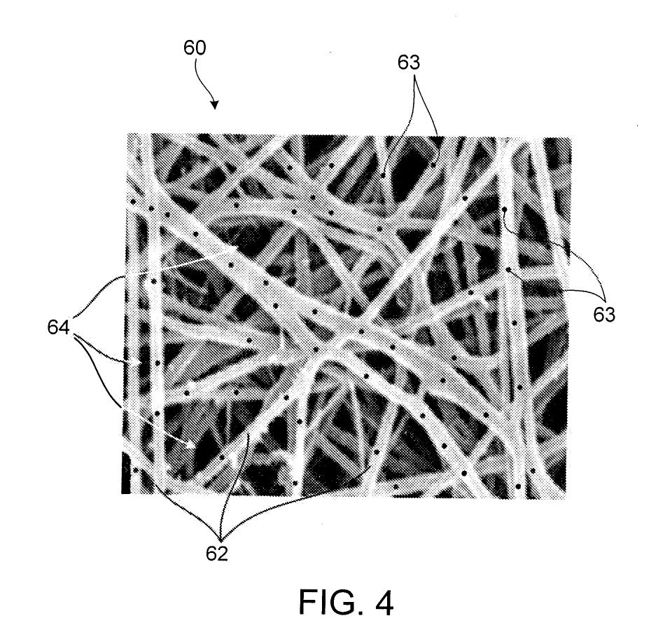

The barrier layer 26 can include one or more electrospun membrane layers, e.g., one or more electrospun nanofiber membranes. For example, FIG. 4 shows an electrospun nanofiber membrane 60 that is suitable for use with the barrier layer 26. As shown in FIG. 4, the electrospun nanofiber membrane 60 includes a plurality of intermingled nanofibers 62 with small pores 64 therebetween. The nanofibers 62 are polymer fibers, e.g., nylon, polyurethane, and/or other synthetic fibers, having fiber diameters in the range of about 50 nanometers to about 1,500 nanometers and including embedded nanoparticles 63 (e.g., magnetite nanoparticles, e.g., oxime-modified magnetitite nanoparticles) having one or more detoxifying properties. It is the fibrous and porous structure that provides the nanofiber membrane with its gas and liquid resistant and vapor permeable properties. The intricate pores 64 of the membrane 60 are large enough to allow moisture vapor generated by the wearer's body to escape, yet are small enough to prevent the smallest droplets of liquid from penetrating the membrane and reaching the wearer's body. The pores 64 provide tortuous passageways and high surface area (i.e., the sum total of the exposed surface areas of the intermingled nanofibers 62 forming the barrier layer 26) to ensure high rate of absorption with hazardous chemicals passing through the barrier layer 26. These properties combine to retard and thwart passage of hazardous chemicals through the outer shell 12.

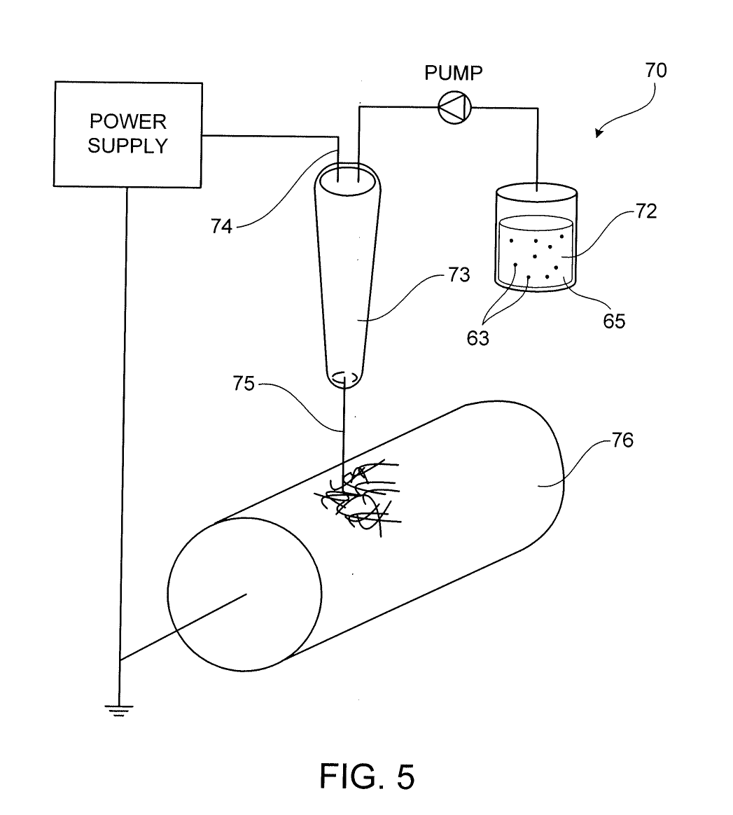

The electrospinning process allows for fine control over the air permeability, water vapor transmission, and liquid resistance of the nanofiber membrane 60. As illustrated in FIG. 5, in the electrospinning process 70, a polymer solution or melt 65 including suspended nanoparticles 63 having one or more detoxifying properties, is pumped from a source 72 to a nanofiber nozzle 73 where a high electrical voltage is applied to the solution or melt (e.g., via a first electrode 74). A jet 75 of the solution or melt is drawn towards a grounded source, e.g., a rotating drum 76, thereby producing a nano sized fiber that includes embedded particles having one or more detoxifying properties. Multiple nanofiber nozzles can be run simultaneous to produce a nano-nonwoven membrane. The nanofibers are collected on the rotating drum 76 to produce a continuous nonwoven membrane. Process controls allow for a great deal of command over pore size, thickness, and fiber diameter, thereby allowing for control over air permeability, water repellency and tortuosity properties of the non-woven membrane.

The electrospun nanofiber membranes can have a weight in the range of about 2 grams per square meter to about 20 grams per square meter, a thickness of about 1 micrometer to about 50 micrometers, and an air permeability in the range of about 0 ft³/ft²/min to about 20 ft³/ft²/min (ASTM D-737, under a pressure difference of ½ inch of water across the membrane).

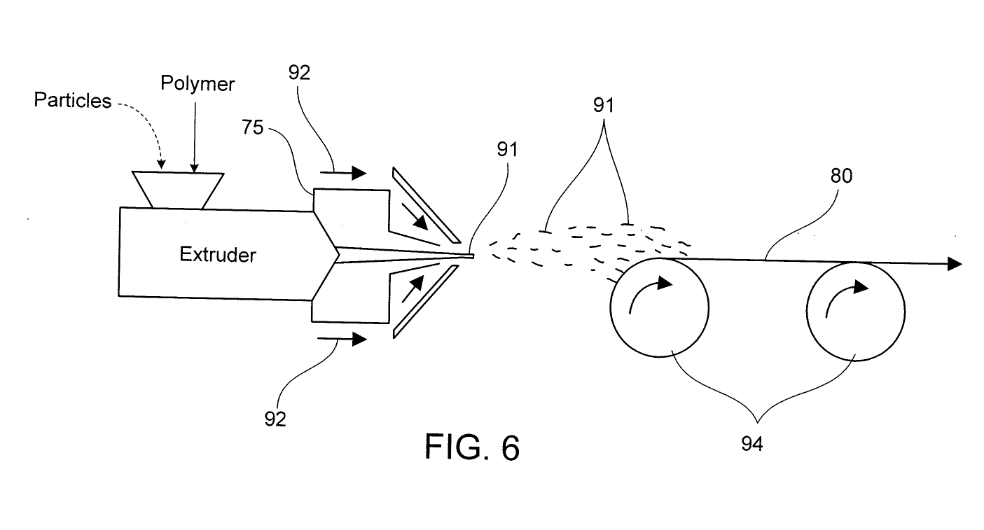

Alternatively or additionally, the barrier layer 26 can include one or more melt blown membrane layers. As shown, for example, in FIG. 6, a melt blown nonwoven membrane 80 can be formed by extruding a molten polymer matrix, including particles having one or more detoxifying properties (e.g., magnetite particles, e.g., magnetite nanoparticles, e.g., oxime-modified magnetitite nanoparticles) suspended in a molten polymer, through a die 90 then attenuating and breaking extruded filaments 91 with hot, high-velocity air 92 to form fibers 93, e.g., having a diameter of about 300 nanometers to about 2,000 nanometers and a few centimeters in length, with embedded particles having one or more detoxifying properties. The fibers 93 are collected on a moving screen 94 where they bond during cooling. The melt blown membrane 80 can have a permeability of about 10 ft³/ft²/min to about 70 ft³/ft²/min (tested according to ASTM D-737, under a pressure difference of ½ inch of water across the first fabric portion).

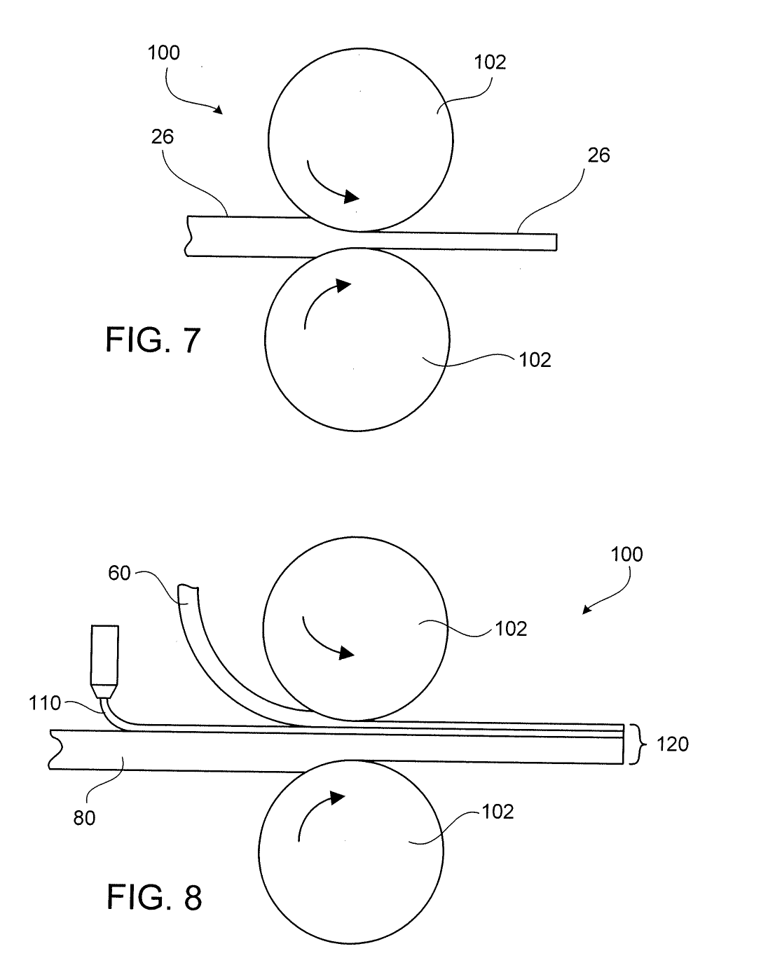

Referring to FIG. 7, prior to lamination with the respective fabric layers, the barrier layer 26 can be compressed by calendar 100 (hot roll) and/or an adhesive may be applied to the barrier layer 26 to get a good bond between the very fine fibers, and to control consistency of the barrier layer 26 as well as maintaining its integrity in usage and after washing. As shown in FIG. 7, in the calendaring operation, the barrier layer 26 is passed between a pair of heated rolls 102 under pressure.

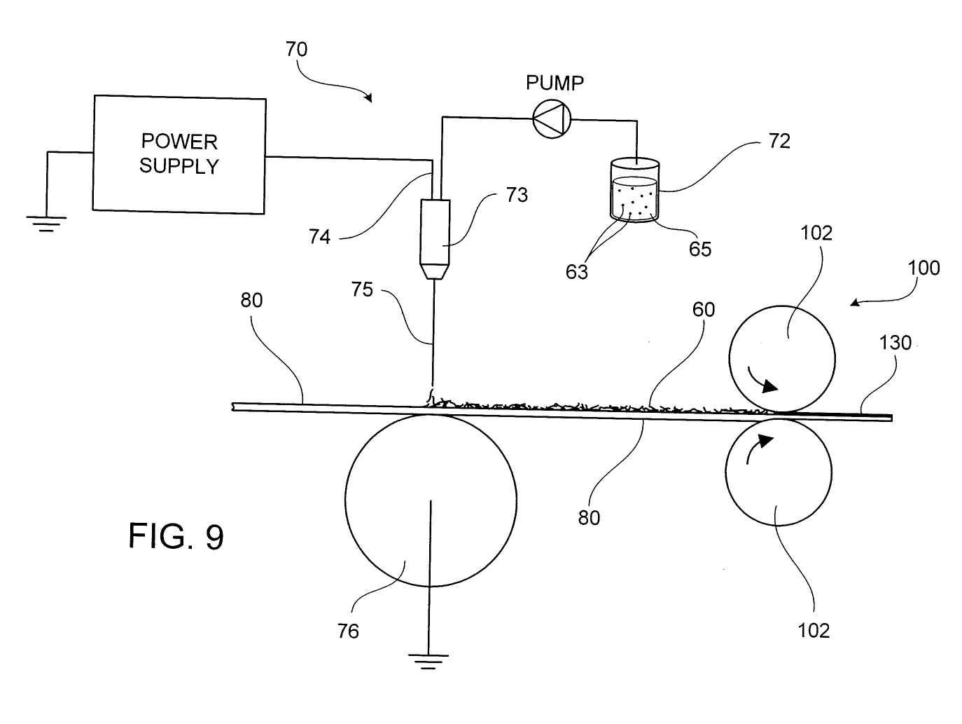

Referring to FIG. 8, in some cases, the barrier layer 26 may include two or more membrane layers 60, 80 (e.g., melt blown and/or electrospun membrane layers), at least one of which includes embedded particles having one or more detoxifying properties. For illustrative purposes, one electrospun membrane 60 and one melt blown membrane 80 are shown in FIG. 8. As illustrated in FIG. 8, the membrane layers 120 can be stacked on top of each other and then pressed together under heat and pressure (e.g., by calendaring), to provide better integrity bond between the membrane layers 60, 80. To further enhance bond strength between the membrane layers 60, 80 an adhesive 110, e.g., a thermosetting or thermoplastic adhesive, can be applied between the membrane layers 60, 80 prior to calendaring. In this manner, multiple membrane layers 60, 80 can be selectively stacked together in order to provide a single nonwoven membrane 120. The stacking of the individual membrane layers provides for precision control of the air permeability of the nonwoven membrane 120.

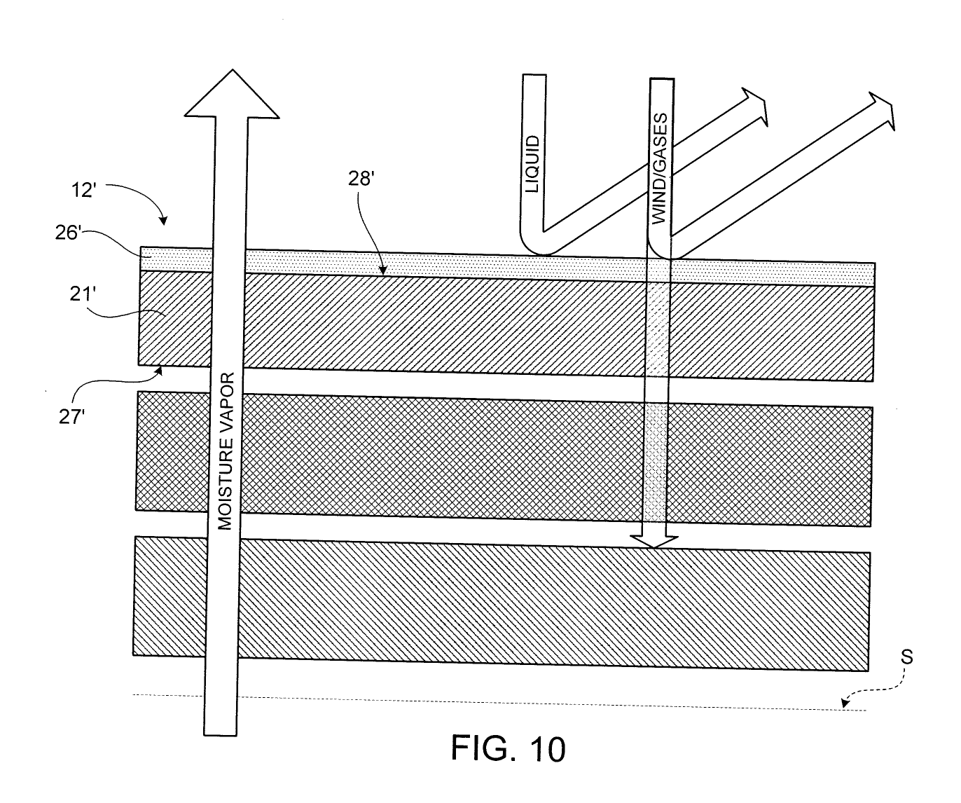

Referring to FIG. 9, in some embodiments, a melt blown nonwoven membrane 80 (e.g., one or more melt blow nonwoven membrane layers) can be used as a carrier on which an electrospun membrane 60 can be deposited as it is produced to form a combined melt blown-electrospun membrane 130. The combined melt blown-electrospun membrane 130 can then compressed by calendar 100.

### Thermal (Intermediate) Fabric Layer (40)

In the intermediate thermal fabric layer 40 (FIG. 2), active carbon fibers or activated carbon particles are embedded in synthetic fibers, formed, e.g., of acrylic, acrylonitrile, nylon, polyester, or other suitable material, including natural fibers such as cotton or wool, which are spun to a textile yarn and knitted in circular knit or warp knit.

Alternatively or additionally, the thermal fabric layer 40 may be constructed from fibers with embedded particles that have one or more detoxifying properties, such as being absorptive of hazardous gases and/or being catalytically destructive of hazardous gases. Suitable particles include particles that are absorptive of hazardous gases such as magnetite particles, e.g., magnetite nanoparticles, e.g., oxime-modified magnetite nanoparticles and particles that have catalytic destructive properties, for catalytic destruction of hazardous gases, such as oxime-modified magnetite particles, e.g., oxime-modified magnetite nanoparticles.

In the case of circular knit, the preferred fabric construction is typically selected from among, e.g., single jersey, plaited jersey, triple plaited jersey, double knit, rib terry, terry loop in regular plaiting or reverse plaiting, and sliver knit (as described below). Terry loop fabric in regular plaiting or reverse plaiting knit construction is physically finished to form a raised surface, e.g., by napping, brushing, or sanding. The raised surface, which can be finished as fleece, velour, shearling or pile and may be in the form of a stand alone fabric or a laminated fabric, will have a large surface area (i.e., the sum total of the surface areas of the fibers forming the volume of the raised surface) and relatively high three-dimensional bulk.

These properties, preferably found in a fabric constructed to have high tortuosity of passageways through the fabric, combine to retard and thwart passage of hazardous chemicals through the fabric. Molecules, including molecules of hazardous chemical, in colloidal suspension are subject to “Brownian” movement (i.e. rapid movement, not in a straight line, but with irregular, rapid, random motion). The bulky, raised-surface thermal fabric layer of the protective fabric (which has relatively higher bulk with lower weight, i.e., as common to THERMALPRO® fabric and WINDPRO® fabric in the POLARTEC® fleece fabric product line manufactured and distributed by Malden Mills Industries, Inc., of Lawrence, Mass., assignee of the present disclosure) resists penetration of hazardous chemical through the fabric. In particular, the high bulk-to-weight ratio, and the large surface area of the raised surface fleece, combines with the Brownian movement to ensure a high rate of absorption of the hazardous chemicals (gas, aerosol, vapor, mist or liquid) by the activated carbon particles embedded in the fibers and on the fiber surfaces, as the narrow passageways serve to ensure that the Brownian movement of the molecules brings the hazardous chemicals into contact with the particles of activated carbon. The raised surface fabric, in single face or double face, serves also as a thermal insulation layer in cold weather conditions. This thermal insulation fabric layer 20, with enhanced tortuosity property, can be made of 100% synthetic fiber yarn containing activated carbon particles, e.g. in the sinker loop yarn and the stitch yarn, or in just the sinker loop yarn, or in just the terry yarn. All of these yarns will be raised by napping, and preferably will have relatively finer denier for increased tortuosity of passageways through the fabric layer, and increased surface area for better absorption by the activated carbon particle. The stitch yarn, which is not raised, can be made of other synthetic yarn or of natural or regenerated yarn. This knit construction may also contain elastomeric yarn in the stitch yarn where the fabric is formed of plaited or reverse plaiting construction.

Alternatively, in another implementation, the intermediate thermal fabric layer 40 may be formed with warp knit construction having high bulk-to-weight ratio in single face or double face, knitted on a double needle bar, e.g. as described in U.S. Pat. No. 5,855,125, the complete disclosure of which is incorporate herein by reference.

In yet another implementation, the intermediate thermal fabric layer 40 may be formed with sliver knit construction having high bulk-to-weight ratio. (Sliver knit is a high loft, knit fabric, e.g. resembling initiation fur, created by locking individual fibers directly into a lightweight knit backing to permit each fiber to stand upright, free from the backing, e.g., as described in Lumb, U.S. Pat. No. 4,513,042, the complete disclosure of which is incorporated herein by reference).

### First (Inner) Layer Garment (50)

A first layer garment 50 (FIG. 2), worn beneath the thermal layer 40, closer to the wearer's skin, S, is important in the layering system for further improving the redundancy of protection.

The first layer garment 50 consists of a fabric formed as a knit textile fabric, e.g. as a single jersey, plaited jersey, double knit, or rib, with or without spandex stretch yarn, where one component yarn, and/or all component yarns, are made of fibers containing activated carbon particles. Alternatively or additionally, the first layer garment 50 may be constructed from fibers with embedded particles that have one or more detoxifying properties, such as being absorptive of hazardous gases and/or being catalytically destructive of hazardous gases. Suitable particles include particles that are absorptive of hazardous gases such as magnetite particles, e.g., magnetite nanoparticles, e.g., oxime-modified magnetite nanoparticles and particles that have catalytic destructive properties, for catalytic destruction of hazardous gases, such as oxime-modified magnetite particles, e.g., oxime-modified magnetite nanoparticles. The first layer garment 50 will preferably still have other comfort properties, e.g. good water management, good stretch recovery, and/or kindness to the wearer's skin, while having high absorption affinity for hazardous chemicals, e.g. in gaseous, vaporous or mist, or liquid state. The inner side 51 of the textile knit fabric, i.e. as a first layer next to the wearer's skin, is brushed to reduce the touching points to the skin and to increase its surface area for enhanced absorption of hazardous chemicals. In other implementations, the textile knit fabric may be brushed on both surfaces to further increase the surface area, and to increase tortuosity of passageways through the fabric layer. As described above, yarns of relatively finer denier are preferred. The embedded activated carbon particles will also enhance the flame-retarding performance of the yarn, especially where the material forming the yarn has some degree of flame-retarding ability.

With stand alone intermediate and inner knit fabric layers the fabric garment system provides for increased protection by redundancy, and improved drapability, breathability and moisture and vapor transmission as compared to, for example, single layer constructions having flocked carbon fibers bound to a base fabric with an adhesive.

### Other Embodiments

While certain embodiments have been described above, other embodiments are possible.

As an example, although an embodiment of an outer fabric shell garment has been described in which particles having one or more detoxifying properties are embedded in the fibers of a barrier layer, in some embodiments, particles having one or more detoxifying properties can, alternatively or additionally, be embedded in a binder that is applied to a fabric surface. For example, FIG. 10 illustrates an embodiment in which an outer shell 12′ is formed of a fabric layer 21′ having a binder 26′ (e.g., a chemical binder, latex, or resin) applied at a an outer surface 28′ of the fabric layer 21′. The binder 26′ contains embedded particles 63 having one or more detoxifying properties. (e.g., magnetite particles, e.g., magnetite nanoparticles, e.g., oxime-modified magnetite nanoparticles) embedded therein. The binder 26′ can be applied by padding or a face application (e.g., foam application, spray application, coating, and/or priming). The fabric layer 21′ has a woven or knit construction (e.g., warp knit, single jersey knit, plated single jersey knit, double knit, tricot knit, and/or terry sinker loop knit). The fabric layer 21′ includes an inner surface 27′, which faces inward, towards the intermediate thermal fabric layer 40 during use, and the outer surface 28′. The inner surface 27′ can be raised and/or brushed. While the binder 26′ is shown on the outer surface 28′, the binder 26′ may be applied to either or both of the inner and outer surfaces 27′, 28′ of the fabric layer 21′. The fabric layer 21′ may be constructed from fibers containing activated carbon particles for added protection against hazardous chemicals.

In some implementations, a binder containing embedded particles having one or more detoxifying properties can, alternatively or additionally, be applied to inner and/or outer surfaces of either or both of the intermediate thermal fabric layer 40 and the first (inner) layer garment 50.

Other details and features combinable with those described herein may be found in U.S. patent application Ser. No. 11/269,040, filed Nov. 8, 2005, the complete disclosure of which is incorporated herein by reference.

A number implementations have been described. Nevertheless, it will be understood that various modifications may be made without departing from the spirit and scope of the disclosure. Accordingly, other implementations are within the scope of the following claims.

What is claimed is:

1. A chemical protective fabric garment, comprising:
a first fabric layer; and
a barrier layer bonded to the first fabric layer, the barrier layer comprising a nonwoven membrane formed of fibers with embedded particles,
wherein the embedded particles are absorptive of hazardous gases and/or are catalytically destructive of hazardous gases.

2. The chemical protective fabric garment of claim 1, wherein the particles have catalytic destructive properties, for catalytic destruction of absorbed hazardous gases.

3. The chemical protective fabric garment of claim 1, wherein the particles comprise magnetite nanoparticles.

4. The chemical protective fabric garment of claim 3, wherein the nanoparticles have an average particle size of about 1 nm to about 100 nm.

5. The chemical protective fabric garment of claim 3, wherein the magnetite nanoparticles comprise oxime-modified magnetite particles.

6. The chemical protective fabric garment of claim 1, wherein the particles are modified with an antidote selected from 2-pralidoxime and poly(4-vinylpyridine-N-phenacyloxime-co-acrylic acid).

7. The chemical protective fabric garment of claim 1, wherein the particles are configured to catalyze hydrolysis of an organophosphate compound, at neutral pH.

8. The chemical protective fabric garment of claim 7, wherein the particles are configured to catalyze the hydrolysis of an organophosphate compound in a temperature range of about 50° F. to about 120° F.

9. The chemical protect fabric garment of claim 7, wherein the organophosphate compound comprises organophosphate ester.

10. The chemical protective fabric garment of claim 7, wherein the organophosphate compound is an organophosphorus pesticide or a chemical warfare agent.

11. The chemical protective fabric garment of claim 1, wherein the barrier layer has an air permeability of about 0 ft³/ft²/min to about 20 ft³/ft²/min, tested according to ASTM D-737, under a pressure difference of ½ inch of water across the barrier layer.

12. The chemical protective fabric garment of claim 1, wherein the barrier layer has a water resistance of about 500 mm of water to about 15,000 mm of water, tested according to AATCC 127-2003, option 2.

13. The chemical protective fabric garment of claim 1, wherein the barrier layer has a moisture vapor transmission rate of about 2,000 g/m²/24 hrs to about 12,000 g/m²/24 hrs, tested according to ASTM E96 inverted cup.

14. The chemical protective fabric garment of claim 1, wherein the barrier layer has a weight of about 2 grams per square meter to about 20 grams per square meter.

15. The chemical protective fabric garment of claim 1, wherein the barrier layer has a thickness of about 1 micrometer to about 50 micrometers.

16. The chemical protective fabric garment of claim 1, wherein the nonwoven membrane is a nanofiber membrane.

17. The chemical protective fabric garment of claim 1, wherein the nonwoven membrane is an electrospun nanofiber membrane.

18. The chemical protective fabric garment of claim 17, wherein the electrospun nanofiber membrane is formed of fibers having fiber diameters in the range of about 50 nanometers to about 1,500 nanometers.

19. The chemical protective fabric garment of claim 18, wherein the particles have an average particle size of about 1 nm to about 100 nm.

20. The chemical protective fabric garment of claim 1, wherein the nonwoven membrane is a melt blown membrane.

21. The chemical protective fabric garment of claim 20, wherein the melt blown membrane is formed of fibers having fiber diameters in the range of about 300 nanometers to about 2,000 nanometers.

22. The chemical protective fabric garment of claim 1, wherein the nonwoven membrane comprises multiple nonwoven membrane layers.

23. The chemical protective fabric garment of claim 22, wherein at least one of the nonwoven membrane layers is a melt blown membrane.

24. The chemical protective fabric garment of claim 22, wherein at least one of the nonwoven membrane layers is an electrospun membrane.

25. The chemical protective fabric garment of claim 22, wherein the nonwoven membrane layers comprise one or more melt blown membrane layers and one or more electrospun membrane layers.

26. The chemical protective fabric garment of claim 1, wherein the first fabric layer is formed of yarns or fibers with embedded particles of activated carbon.

27. The chemical protective fabric garment of claim 1, wherein the first fabric layer is formed of yarns or fibers with embedded particles that are absorptive of hazardous gases and/or are catalytically destructive of hazardous gases.

28. The chemical protective fabric garment of claim 1, further comprising a second fabric layer, wherein the barrier layer is disposed between the first and second fabric layers.

29. The chemical protective fabric garment of claim 28, wherein the first fabric layer and/or the second fabric layer are formed of yarns or fibers with embedded particles of activated carbon.

30. The chemical protective fabric garment of claim 28, wherein the first fabric layer and/or the second fabric layer are formed of yarns or fibers with embedded particles that are absorptive of hazardous gases and/or are catalytically destructive of hazardous gases.

31. A method of forming a chemical protective fabric, the method comprising:
bonding a barrier layer comprising a nonwoven membrane formed of fibers with embedded particles to a first fabric layer,
wherein the embedded particles are absorptive of hazardous gases and/or are catalytically destructive of hazardous gases.

32. The method of claim 31, further comprising forming the barrier layer.

33. The method of claim 32, wherein forming the barrier layer comprises forming nanofibers with the particles embedded therein.

34. The method of claim 32, wherein forming the barrier layer comprises stacking multiple membrane layers on top of each other, and mechanically processing the stack of membrane layers.

35. The method of claim 34, wherein mechanically processing the stack of membrane layers comprises applying heat and pressure to the stack of membrane layers.

36. The method of claim 35, wherein pressure is applied by passing the stack of membrane layers through a plurality of rollers.

37. The method of claim 36, wherein the rollers are heated.

38. The method of claim 34, wherein stacking the multiple membrane layers comprises electrospinning a nonwoven membrane layer onto a carrier membrane layer.

39. The method of claim 38, further comprising forming the carrier membrane out of a melt-blown non-woven membrane.

40. The method of claim 31, wherein the particles comprise magnetite particles.

41. The method of claim 31, wherein the particles comprise oxime-modified magnetite particles.

42. The method of claim 31, further comprising bonding the barrier layer to a second fabric layer.

43. A chemical protective fabric garment system, comprising:
an inner layer garment having an inner surface, towards a wearer's skin, brushed for increased surface area to provide enhanced absorption and reduced touching points upon the skin;
a thermal fabric garment configured to be worn over the inner layer garment, the thermal fabric garment having at least one raised surface; and
an outer shell garment configured to be worn over the thermal fabric garment, the outer shell garment comprising:
a first fabric layer; and
a barrier layer bonded to the first fabric layer, the barrier layer comprising a nonwoven membrane formed of fibers with embedded particles,
wherein the embedded particles are absorptive of hazardous gases and/or are catalytically destructive of hazardous gases.

44. The chemical protective fabric garment system of claim 43, wherein the particles comprise magnetite particles.

45. The chemical protective fabric garment system of claim 44, wherein the magnetite particles comprise magnetite nanoparticles.

46. The chemical protective fabric garment system of claim 44, wherein the magnetite particles comprise oxime-modified magnetite particles.

47. The chemical protective fabric garment system of claim 43, wherein the nonwoven membrane comprises an electrospun nanofiber membrane.

48. The chemical protective fabric garment system of claim 43, wherein the nonwoven membrane comprises a melt blown membrane.

49. The chemical protective fabric garment system of claim 43, wherein the nonwoven membrane comprises multiple membrane layers.

50. The chemical protective fabric garment system of claim 49, wherein at least one of the membrane layers is a melt blown membrane.

51. The chemical protective fabric garment system of claim 49, wherein at least one of the membrane layers is an electrospun membrane.

52. The chemical protective fabric garment system of claim 49, wherein the membrane layers comprise one or more melt blown membrane layers and one or more electrospun membrane layers.

53. The chemical protective fabric garment system of claim 43, wherein the first fabric layer is formed of yarns or fibers with embedded particles of activated carbon.

54. The chemical protective fabric garment of claim 43, wherein the first fabric layer is formed of yarns or fibers with embedded particles that are absorptive of hazardous gases and/or are catalytically destructive of hazardous gases.

55. The chemical protective fabric garment system of claim 43, wherein the outer shell garment further comprises a second fabric layer, wherein the barrier layer is disposed between the first and second fabric layers.

56. The chemical protective fabric garment of claim 55, wherein the first fabric layer and/or the second fabric layer are formed of yarns or fibers with embedded particles of activated carbon.

57. The chemical protective fabric garment system of claim 55, wherein the first fabric layer and/or the second fabric layer are formed of yarns or fibers with embedded particles that are absorptive of hazardous gases and/or are catalytically destructive of hazardous gases.

58. The chemical protective fabric garment system of claim 43, wherein the thermal fabric garment is formed of one or more yarns made of fibers carrying activated carbon particles.

59. The chemical protective fabric garment system of claim 43, wherein the thermal fabric garment is formed of one or more yarns made of fibers with embedded particles that are absorptive of hazardous gases and/or are catalytically destructive of hazardous gases

60. The chemical protective fabric garment system of claim 43, wherein the thermal fabric garment is formed of synthetic yarns or fibers with embedded particles of activated carbon or active carbon fiber.

61. The chemical protective fabric garment system of claim 43, wherein the thermal fabric garment is formed of synthetic yarns or fibers with embedded particles that are absorptive of hazardous gases and/or are catalytically destructive of hazardous gases.

62. A chemical protective fabric garment, comprising:
a first fabric layer;
a second fabric layer; and
a barrier layer disposed between the first fabric layer and the second fabric layer, the barrier layer comprising a nonwoven membrane formed of fibers with embedded particles,
wherein the embedded particles are absorptive of hazardous gases and/or are catalytically destructive of hazardous gases.
